(19) United States
(12) Patent Application Publication
(10) Pub. No.: US 2019/0114183 A1
(43) Pub. Date: Apr. 18, 2019

(54) Terminal Configuration Method and Terminal Based on Provision Protocol for Transmission

(71) Applicant: JRD COMMUNICATION (SHENZHEN) LTD, Shenzhen (CN)

(72) Inventors: Jingcan Chen, Shenzhen (CN); Kaihui Huang, Shenzhen (CN)

(21) Appl. No.: 16/228,736

(22) Filed: Dec. 20, 2018

Related U.S. Application Data
(63) Continuation of application No. PCT/CN2017/092210, filed on Jul. 7, 2017.

(30) Foreign Application Priority Data
Aug. 16, 2016 (CN) 201610671490.7

(51) Int. Cl. G06F 9/445; H04L 12/24; H04L 12/58; H04L 29/08

(52) U.S. Cl. CPC G06F 9/44505; H04L 41/0806; H04L 67/06; H04L 67/303; H04L 51/08

(57) ABSTRACT

A terminal configuration method and system based on a provision protocol for transmission are disclosed. The method comprises: receiving, by a first terminal, a configuration instruction used for configuring a second terminal to form a configuration file; sending, by the first terminal, the configuration file to the second terminal in the manner of a provision text message; and receiving the configuration file by the second terminal and installing the second terminal in terms of the configuration file when an instruction to install the configuration file is received. In this way, the first terminal can remotely assist the second terminal in configuration modification, and thus, the problem that users are unable to independently complete terminal configuration can be solved.

### CROSS REFERENCE TO RELATED APPLICATIONS

The present application is a continuation-application of International (PCT) Patent Application No. PCT/CN2017/092210 filed on Jul. 7, 2017, which claims foreign priority of Chinese Patent Application No. 201610671490.7, filed on Aug. 16, 2016 in the State Intellectual Property Office of China, the entire contents of which are hereby incorporated by reference.

### TECHNICAL FIELD

The disclosure relates to the technical field of mobile communications, in particular to a terminal configuration method and a terminal based on a provision protocol for transmission.

### BACKGROUND

With the continuous development and popularization of the mobile communication technology, smart phones have been widely applied. As people have more and more requirements, the smart phones have gained more and more functions, and accordingly, configuration operation is becoming more and more complex. For this reason, not every user can accurately and rapidly modify the configuration of their smart phones, and particularly the elderly who like to use smart phones are unable to configure their smart phones according to personal preferences.

It is impossible for these users to get help from other users every time. For instance, when there is no other user nearby, these users cannot modify the configuration of their smart phones instantly. An existing solution to such problem is to provide remote assistance, similar to QQ, for these users. However, access to the Internet is needed when this method is adopted, and operation is very inconvenient.

### SUMMARY

The main technical problem of the present disclosure to be solved is to provide a terminal configuration method and a terminal based on a provision protocol for transmission. By adoption of the terminal configuration method, a first terminal can remotely assist a second terminal in configuration modification, so that the problem that users are unable to independently complete terminal configuration is solved.

One technical solution adopted by the present disclosure is to provide a terminal configuration method based on a provision protocol for transmission. The terminal configuration method may comprise the blocks: receiving, by a first terminal, a configuration instruction for configuring a second terminal to form a configuration file; sending, by the first terminal, the configuration file to the second terminal in the manner of a provision text message; receiving, by the second terminal, the configuration file and installing the configuration file when an instruction to install the configuration file is received by the second terminal.

Another technical solution adopted by the present disclosure is to provide a terminal based on a provision protocol for transmission. The terminal may comprise a processor, a storage and a transceiver, wherein the memory and the transceiver are coupled to the processor; wherein the processor is configured to receive a configuration instruction for configuring a second terminal through the transceiver to form a configuration file, and send the configuration file to the second terminal in a manner of a provision text message through the transceiver, so that the configuration file is installed by the second terminal; the storage is configured to store the configuration file.

Another technical solution adopted by the present disclosure to provide a terminal based on a provision protocol for transmission. The terminal may comprise a processor, a storage and a transceiver, wherein the memory and the transceiver are coupled to the processor; the processor is configured to receive a configuration file from a first terminal in a manner of a provision text message through the transceiver, wherein the configuration file is formed by the first terminal when the first terminal receives a configuration instruction for configuring the terminal; and the processor is configured to install the configuration file; the storage is configured to store the configuration file.

The present disclosure may have the following beneficial effects: the first terminal may receive the configuration instruction for configuring the second terminal to form the configuration file, the configuration file may be sent to the second terminal in the manner of the provision text message, the second terminal may receive the configuration file and be configured in terms of the configuration file. Therefore, the first terminal can remotely assist the second terminal in configuration modification, and the problem that users cannot independently complete terminal configuration can be solved.

### BRIEF DESCRIPTION OF THE DRAWINGS

FIG. 1 is a flow diagram of one embodiment of a terminal configuration method of the present disclosure;

FIG. 2 is a flow diagram of a first embodiment of a first terminal configuration method of the present disclosure;

FIG. 3 is a flow diagram of a second embodiment of the first terminal configuration method of the present disclosure;

FIG. 4 is a flow diagram of a first embodiment of a second terminal configuration method of the present disclosure;

FIG. 5 is a flow diagram of a second embodiment of the second terminal configuration method of the present disclosure;

FIG. 6 is a structural view of one embodiment of a terminal configuration system of the present disclosure;

FIG. 7 is a structural view of a first embodiment of a first terminal configuration system of the present disclosure;

FIG. 8 is a structural view of a second embodiment of the first terminal configuration system of the present disclosure;

FIG. 9 is a structural view of a first embodiment of a second terminal configuration system of the present disclosure;

FIG. 10 is a structural view of a second embodiment of the second terminal configuration system of the present disclosure;

FIG. 11 is a structural view of a third embodiment of the first terminal configuration system of the present disclosure;

FIG. 12 is a structural view of a third embodiment of the second terminal configuration system of the present disclosure.

### DETAILED DESCRIPTION

The present disclosure is detailed below with reference to the accompanying drawings and embodiments.

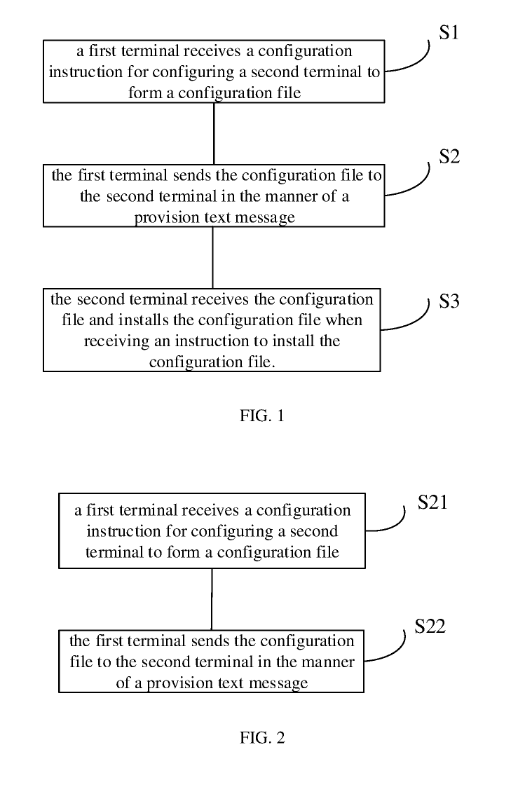

Please refer to FIG. 1 which is a flow diagram of one embodiment of a terminal configuration method of the present disclosure. It can be noted that a smart phone is used as an example in embodiments, but those skilled in the art would understand that the terminal is not limited to the mobile phone. Other smart mobile terminal devices with a provision protocol-based transmission function such as tablet computers can also adopt the method in embodiments of the present disclosure. As shown in FIG. 1, the terminal configuration method may comprise actions at blocks S1 to S3.

S1, a first terminal receives a configuration instruction for configuring a second terminal to form a configuration file.

The second terminal can send a configuration requirement to the first terminal by making a call, sending a text message or sending a message through communication software such as WhatsApp, MSN, QQ and Facebook. For instance, user B of the second terminal may make a call to user A of the first terminal to inform the user A of the requirement for switching the language environment of the mobile phone to Chinese, the requirement for turning the mobile phone brighter, or the requirement for solving the problem that the mobile phone has no access to the Internet. After receiving the configuration requirement from the second terminal, the first terminal may select setting items through an editing interface and set options of the setting items according to the requirements of user B, and the configuration file can be formed after all the operation is completed;

In some embodiments, the configuration requirement can be directly transmitted through communications between the users rather than being transmitted to the first terminal by the second terminal.

S2, the first terminal sends the configuration file to the second terminal in the manner of a provision text message.

Particularly, the first terminal may receive the configuration requirement to configure the second terminal by answering a call or in other ways. The first terminal may complete configuration through an editing interface to form the configuration file according to the configuration requirement and then pack the configuration file into provision information so as to send the configuration file to the second terminal in the manner of a text message.

S3, the second terminal receives the configuration file and installs the configuration file when receiving an instruction to install the configuration file.

Particularly, after the second terminal receives the provision information sent from the first terminal in the manner of the text message, the configuration file can be analyzed. When receiving the instruction to install the configuration file, the second terminal can install the configuration file. For instance, after receiving the provision information sent from user A of the first terminal, user B of the second terminal can unpack the provision information and select installation information, the system may analyze the provision information into the configuration file for installation and then further analyze the configuration file, and finally, the second terminal can be configured according to the configuration file.

Through above blocks, the first terminal can remotely assist the second terminal in configuration modification, and the problem that user B is unable to independently complete terminal configuration can be solved.

As shown in FIG. 2 which is a flow diagram of a first embodiment of a first terminal configuration method, the first terminal configuration method may comprise actions at blocks S21 to S22:

S21, a first terminal receives a configuration instruction for configuring a second terminal to form a configuration file.

After receiving a configuration requirement from the second terminal by answering a call or listening to a message, the first terminal may select setting items through the editing interface, set options of the setting items according to the configuration requirement sent by the second terminal to form the configuration file.

S22, the first terminal sends the configuration file to the second terminal in the manner of a provision text message, so that the second terminal is configured in terms of the configuration file.

The configuration file may be packed into provision information and sent to the second terminal in the manner of a text message by the first terminal.

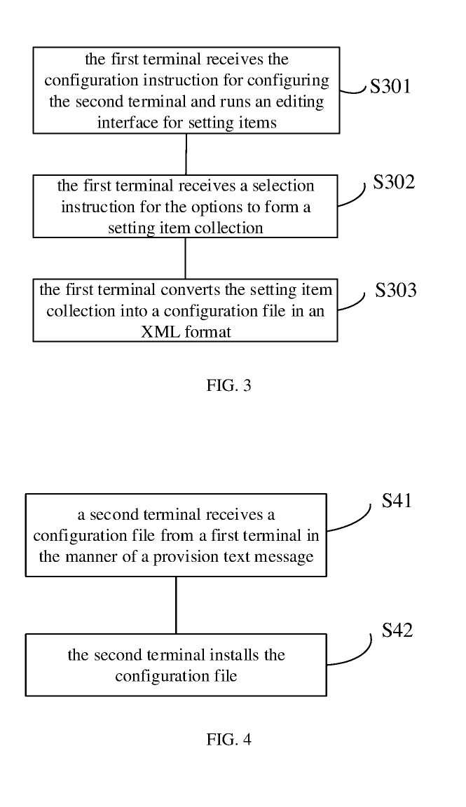

FIG. 3 is a flow diagram of a second embodiment of the first terminal configuration method of the present disclosure. Based on the embodiment shown in FIG. 2, block S1 may further comprise actions at blocks S301 to S303:

S301, the first terminal receives the configuration instruction for configuring the second terminal and runs an editing interface for setting items, options of the setting items are displayed on the editing interface.

S302, the first terminal receives a selection instruction for the options to form a setting item collection.

S303, the first terminal converts the setting item collection into a configuration file in an XML format.

The editing interface for the setting items can be a software program or an APP program running on the first terminal. For instance, user A of the first terminal may receive a configuration requirement for switching the language environment of the mobile phone to Chinese, turning the mobile phone brighter or solving the problem of having no access to the Internet of the mobile phone, from user B of the second terminal. User A may select “add setting items” through the editing interface, the page may show setting options of Android, “Chinese (simplified)” can be selected in the “language” option, and after the selected option can be saved, the next option can be selected next. When user A completes all setting items needed to be set for user B, the system of the first terminal may convert the added setting items into the configuration file in the XML format, further pack the configuration file in the XML format into provision information and send the configuration file to the second terminal in the manner of a text message. The system of terminals may include, but is not limited to, Android operating system or iOS operating system.

According to blocks of the present embodiment, the first terminal may receive the configuration instruction for configuring the second terminal, locally form the configuration file according to the configuration requirement of the second terminal and send the configuration file to the second terminal in the manner of a provision text message to remotely assist the second terminal in completing terminal configuration.

FIG. 4 is a flow diagram of a first embodiment of a second terminal configuration method of the present disclosure. The second terminal configuration method may comprise actions at blocks S41 to S42:

S41, a second terminal receives a configuration file from a first terminal in the manner of a provision text message, and the configuration file is formed by a first terminal when the first terminal receives a configuration instruction for configuring the second terminal.

S42, the second terminal installs the configuration file.

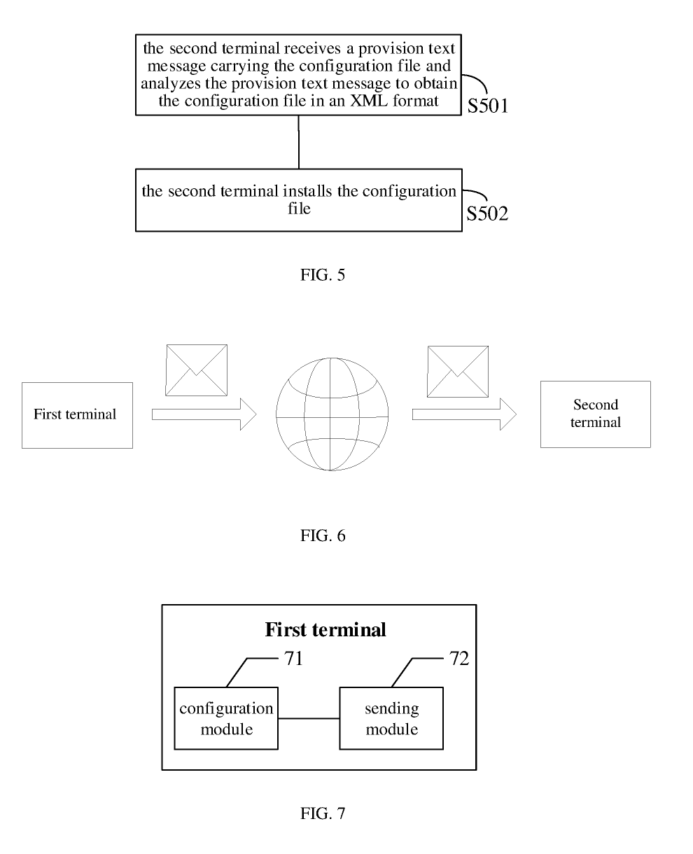

FIG. 5 is a flow diagram of a second embodiment of the second terminal configuration method of the present disclosure. Based on the embodiment shown in FIG. 4, step S42 further comprises actions at blocks S501 to S502:

S501, the second terminal receives a provision text message carrying the configuration file and analyzes the provision text message to obtain the configuration file in an XML format.

S502, the second terminal installs the configuration file.

The second terminal may receive the configuration file from the first terminal in the manner of a text message, and after the message is unpacked, user B of the second terminal can select the configuration file to install. For instance, after receiving the provision text message, user B may unpack the message and select “configuration information (installation)”, and then the system of the second terminal analyze the provision message into an XML file and then further analyze the XML file to complete the configuration of the second terminal. Before configuration information is installed, user B can select all options to install or some options according to their requirements.

In some embodiments, for the sake of security, sending/receiving permissions can be set at the second terminal when the second terminal receives a setting instruction. For instance, taking a smart phone as an example, phone number permission or contacts permission can be set at the second terminal to only receive provision text messages sent from specific numbers or specific contacts. Therefore, malicious provision text message with configuration information sent from strangers can be prevented. The Malicious provision text messages sent from unfamiliar numbers or contacts can be intercepted by the second terminal.

According to above blocks, the second terminal may receive the configuration file sent from the first terminal and install the configuration file. Therefore, the problem that the second terminal is unable to independently complete terminal configuration can be solved.

FIG. 6 is a structural view of one embodiment of a terminal configuration system of the present disclosure. As shown in FIG. 6, a first terminal may send a provision text message to a second terminal through networks or text messages, and the second terminal can receive the configuration file from the first terminal in the manner of the provision text message and install the configuration file.

FIG. 7 is a structural view of a first embodiment of a first terminal configuration system of the disclosure. As shown in FIG. 7, the first terminal configuration system may comprise a configuration module 71 and a sending module 72.

The configuration module 71 may be configured to receive a configuration instruction for configuring a second terminal to form a configuration file.

The sending module 72 may be configured to send the configuration file to the second terminal in the manner of a provision text message, so that the configuration file can be the second terminal.

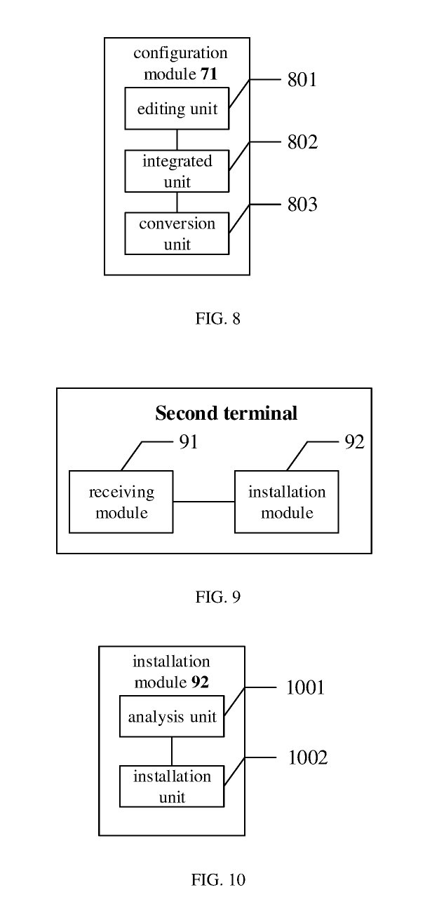

As shown in FIG. 8 which is a structural view of a second embodiment of the first terminal configuration system of the present disclosure, the configuration module 71 may comprise an editing unit 801, an integrated unit 802 and a conversion unit 803. The editing unit 801 may be configured to run an editing interface for setting items, and the options of the setting items can be displayed on the editing interface. The integrated unit 802 may be configured to receive a selection instruction for the options to form a setting item collection. The conversion unit 803 may be configured to convert the setting item collection into the configuration file in an XML format.

The first terminal configuration system can perform the blocks of the first terminal configuration method. Please refer to the detailed description of the above-mentioned method for relevant contents, which are no longer given herein.

FIG. 9 is a structural view of a first embodiment of a second terminal configuration system of the present disclosure. As shown in FIG. 9, the second terminal configuration system may comprise a receiving module 91 and an installation module 92.

The receiving module 91 may be configured to receive a configuration file from a first terminal. The configuration file may be formed by the first terminal when the first terminal receives a configuration instruction for configuring the second terminal.

The installation module 92 may be configured to install the configuration file.

As shown in FIG. 10 which is a structural view of a second embodiment of the second terminal configuration system of the present disclosure, the installation module 92 may further comprise an analysis unit 1001 and an installation unit 1002. The analysis unit 1001 may be configured to analyze the provision text message to obtain the configuration file in an XML format. The installation unit 1002 may be configured to install the configuration file.

The second terminal configuration system can perform the blocks of the second terminal configuration method. Please refer to the detailed description of the above-mentioned method for the relevant contents which are no longer given herein.

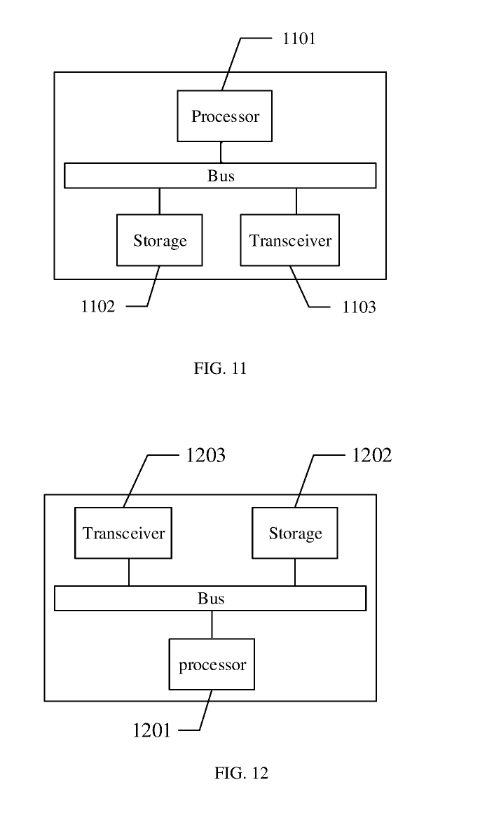

FIG. 11 is a structural view of a third embodiment of the first terminal configuration system of the present disclosure. In this embodiment, a processing unit may comprise a processor 1101, a storage 1102 and a transceiver 1103. The storage 1102 and the transceiver 1103 may be coupled to the processor 1101.

The storage 1102 may be configured to store an operating system, operating software, instructions to be executed by the processor 1101, the received configuration instruction for configuring the second terminal, the configuration file formed by the first terminal to configure the second terminal, and the like.

The processor 1101 may be configured to send the configuration file to the second terminal in the manner of a provision text message through the transceiver 1103, so that the second terminal can be configured in terms of the configuration file.

The processor 1101 may be configured to execute the configuration instruction to form the configuration file. The configuration requirement may be received from the second terminal to configure the second terminal. Particularly, the processor 1101 may be configured to receive the configuration instruction for configuring the second terminal through the transceiver 1103 and run an editing interface of setting items. Options of the setting items may be displayed on the editing interface. The processor 1101 may be configured to receive a selection instruction for the options to form a setting item collection and to convert the setting item collection into the configuration file in the XML format.

Please refer to FIG. 12, FIG. 12 is a structural view of a third embodiment of the second terminal configuration system of the present disclosure. A terminal based on a provision protocol for transmission may comprise a processor 1201, a storage 1202 and a transceiver 1203, the storage 1202 and the transceiver 1203 may be coupled to the processor 1201.

The processor 1201 may be configured to receive a configuration file from a first terminal in a manner of a provision text message through the transceiver 1203. The configuration file may be formed by the first terminal when the first terminal receives a configuration instruction for configuring the terminal. The processor 1201 may be configured to install the configuration file.

The storage 1202 may be configured to store the configuration file.

In the above solutions, the first terminal may receive the configuration instruction for configuring the second terminal to complete setting items and form the configuration file. The configuration file may be sent to the second terminal in the manner of a provision text message; the second terminal may receive the configuration file and be configured in terms of the configuration file. Therefore, the first terminal can remotely assist the second terminal in configuration modification, and the problem that users are unable to independently complete terminal configuration can be solved.

It should be understood that the methods and systems disposed in the several embodiments of the present disclosure can also be implemented in other ways. For instance, all the functional units in the embodiments of the present disclosure can be integrated into one processing unit or can be physically separated from one another, or two or more units are integrated in one unit. The aforesaid integrated units can be realized in a form of hardware or can be realized in a form of software function units. Meanwhile, partitioning of modules or units is only based on the logic function, but in actual implementations, partitioning can also be conducted in other ways, for instance, multiple units or assemblies can be combined or integrated into another system, or certain characteristics can be omitted or not be implemented. In addition, coupling, direct coupling, or communication connection mentioned or discussed above can be realized via certain interfaces, and indirect coupling or communication connection between devices or units can be realized electrically, mechanically, or in other forms.

The above description is only used to explain certain embodiments of the present disclosure, but is not intended to limit the patent scope of the present disclosure. All equivalent structures or equivalent flow transformations based on the contents in the specifications and accompanying drawings, or direct or indirect applications to other relevant technical fields should also fall within the patent protection scope of the disclosure.

What is claimed is:

1. A terminal configuration method based on a provision protocol for transmission, comprising:
receiving, by a first terminal, a configuration instruction for configuring a second terminal to form a configuration file;
sending, by the first terminal, the configuration file to the second terminal in a manner of a provision text message; and
receiving the configuration file by the second terminal and installing the configuration file when an instruction to install the configuration file is received by the second terminal.

2. The method according to claim 1, wherein,
the receiving, by the first terminal, the configuration instruction for configuring the second terminal to form the configuration file comprises:
receiving, by the first terminal, the configuration instruction for configuring the second terminal to form a setting item collection; and
converting the setting item collection into the configuration file in an XML format by the first terminal.

3. The method according to claim 2, wherein,
the receiving, by the first terminal, the configuration instruction for configuring the second terminal to form the setting item collection comprises:
receiving, by the first terminal, the configuration instruction for configuring the second terminal to run an editing interface for setting items, wherein options of the setting items are displayed on the editing interface; and
receiving a selection instruction for the options to form the setting item collection.

4. The method according to claim 1, wherein,
the receiving the configuration file by the second terminal comprises:
receiving, by the second terminal, the provision text message carrying the configuration file; and
analyzing the provision text message to obtain the configuration file in an XML format.

5. The method according to claim 1, wherein,
the receiving, by the first terminal, the configuration instruction for configuring the second terminal to form the configuration file comprises:
receiving a configuration requirement, by the first terminal, from the second terminal;
receiving the configuration instruction corresponding to the configuration requirement.

6. The method according to claim 1, wherein,
before receiving the configuration file by the second terminal and installing the configuration file when the instruction to install the configuration file is received by the second terminal comprises
receiving a setting instruction by the second terminal;
setting receiving permissions according to the setting instruction by the second terminal, so that the second terminal is permitted to receive the configuration file from the first terminal.

7. A terminal based on a provision protocol for transmission comprising a processor, a storage and a transceiver, wherein the storage and the transceiver are coupled to the processor;
wherein the processor is configured to receive a configuration instruction for configuring a second terminal through the transceiver to form a configuration file, and send the configuration file to the second terminal in a manner of a provision text message through the transceiver, so that the configuration file is installed by the second terminal;
the storage is configured to store the configuration file.

8. The terminal according to claim 7, wherein the processor is configured to receive the configuration instruction for configuring the second terminal through the transceiver to form a setting item collection, and convert the setting item collection into the configuration file in an XML format.

9. The terminal according to claim 8, wherein the processor is configured to receive the configuration instruction for configuring the second terminal through the receiver and runs an editing interface for setting items, wherein options of the setting items are displayed on the editing interface; and the processor is further configured to receive a selection instruction for the options to form the setting item collection.

10. A terminal based on a provision protocol for transmission, wherein the terminal comprises a processor, a storage and a transceiver, wherein the storage and the transceiver are coupled to the processor;
the processor is configured to receive a configuration file from a first terminal in a manner of a provision text message through the transceiver, wherein the configuration file is formed by the first terminal when the first terminal receives a configuration instruction for configuring the terminal; and the processor is configured to install the configuration file;
the storage is configured to store the configuration file.

11. The terminal according to claim 10, wherein the processor is configured to receive the provision text message carrying the configuration file through the transceiver and analyze the provision text message to obtain the configuration file in an XML format.

12. The terminal according to claim 10, wherein the processor is configured to set receiving permissions so as to only receive the configuration file from the first terminal which is preset.
